(19) United States
(12) Patent Application Publication
(10) Pub. No.: US 2026/0147431 A1
(43) Pub. Date: May 28, 2026

(54) DISPLAY DEVICE AND ELECTRONIC DEVICE INCLUDING THE SAME

(71) Applicant: Samsung Display Co., Ltd., Yongin-si (KR)

(72) Inventors: EUNSOL SEO, Yongin-si (KR); Min-Hong Kim, Yongin-si (KR); Sangkook Kim, Yongin-si (KR)

(73) Assignee: Samsung Display Co., Ltd., Yongin-si (KR)

(21) Appl. No.: 19/337,410

(22) Filed: Sep. 23, 2025

(30) Foreign Application Priority Data
Nov. 27, 2024 (KR) 10-2024-0171893

(51) Int. Cl. G06F 3/041

(52) U.S. Cl. CPC G06F 3/04184

(57) ABSTRACT

A display device, including: a display panel configured to display an image; a touch panel configured to detect a touch; a display panel driver configured to drive the display panel according to a variable frequency mode, and to modulate a vertical synchronization signal to generate a touch vertical synchronization signal; and a touch panel driver configured to determine a driving timing of the touch panel based on the touch vertical synchronization signal, and to match the driving timing of the touch panel to a driving timing of the display panel to drive the touch panel according to the variable frequency mode.

This application is based on and claims priority under 35 USC § 119 to Korean Patent Application No. 10-2024-0171893, filed on Nov. 27, 2024, in the Korean Intellectual Property Office, the disclosure of which is incorporated by reference herein in its entirety.

### BACKGROUND

### 1. Field

The present disclosure relates to a display device and an electronic device including the same, and more particularly to a display device and an electronic device including the same for synchronizing a driving timing of a touch panel with a driving timing of a display panel.

### 2. Description of the Related Art

A display device may include a display module and a touch module. The display module may include a display panel that displays an image and a display panel driver that drives the display panel, and the touch module may include a touch panel that detects a user's touch and a touch panel driver that drives the touch panel.

The display module may be driven in a variable frequency mode that displays an image at a variable frequency. The display panel driver may provide a signal for the driving timing of the display panel to the touch panel driver, and the touch panel driver may be driven in the variable frequency mode by synchronizing the driving timing of the touch panel to the driving timing of the display panel based on the signal for the driving timing of the display panel.

Meanwhile, when the driving timing of the touch panel does not match the driving timing of the display panel, a delay phenomenon may occur in which the image of the display panel responds late to the user's touch. For example, when the user performing web surfing scrolls down through the touch panel, the image of the display panel may scroll down late.

### SUMMARY

Provided is a display device for synchronizing a driving timing of a touch panel with a driving timing of a display panel.

Also provided is an electronic device including the display device.

In accordance with an aspect of the disclosure, a display device includes: a display panel configured to display an image; a touch panel configured to detect a touch; a display panel driver configured to drive the display panel according to a variable frequency mode, and to modulate a vertical synchronization signal to generate a touch vertical synchronization signal; and a touch panel driver configured to determine a driving timing of the touch panel based on the touch vertical synchronization signal, and to match the driving timing of the touch panel to a driving timing of the display panel to drive the touch panel according to the variable frequency mode.

The display panel driver may be further configured to, based on a driving frequency of the display panel being changed from a first driving frequency to a second driving frequency different from the first driving frequency, modulate an initial pulse of the vertical synchronization signal in at least one frame having the second driving frequency.

The display panel driver may be further configured to maintain a remaining pulse of the vertical synchronization signal in at least one frame having the second driving frequency.

The display panel driver may be further configured to modulate a voltage of the initial pulse of the vertical synchronization signal.

Based on the driving frequency of the display panel being changed to the second driving frequency, the voltage of the initial pulse of the vertical synchronization signal is changed in at least one frame having the second driving frequency.

The display panel driver may be further configured to modulate a voltage and a number of the initial pulse of the vertical synchronization signal.

Based on the driving frequency of the display panel being changed to the second driving frequency, the voltage and the number of the initial pulse of the vertical synchronization signal are changed in at least one frame having the second driving frequency.

A frame period of the display panel may include an active period and a blank period.

The initial pulse of the vertical synchronization signal may be included in the active period.

A frame period of the display panel may include a front porch period, an active period, and a back porch period.

The initial pulse of the vertical synchronization signal may be included in the back porch period.

In accordance with an aspect of the disclosure, an electronic device, includes: a host processor configured to output a vertical synchronization signal; a display panel configured to display an image; a touch panel configured to detect a touch; a display panel driver configured to drive the display panel according to a variable frequency mode, and to modulate the vertical synchronization signal to generate a touch vertical synchronization signal; and a touch panel driver configured to determine a driving timing of the touch panel based on the touch vertical synchronization signal, and to match the driving timing of the touch panel to a driving timing of the display panel to drive the touch panel according to the variable frequency mode

The display panel driver may be further configured to, based on a driving frequency of the display panel being changed from a first driving frequency to a second driving frequency different from the first driving frequency, modulate an initial pulse of the vertical synchronization signal in at least one frame having the second driving frequency.

The display panel driver may be further configured to maintain a remaining pulse of the vertical synchronization signal in at least one frame having the second driving frequency.

The display panel driver may be further configured to modulate a voltage of the initial pulse of the vertical synchronization signal.

Based on the driving frequency of the display panel being changed to the second driving frequency, a voltage of the initial pulse of the vertical synchronization signal is changed in at least one frame having the second driving frequency.

The display panel driver may be further configured to modulate the voltage of the vertical synchronization signal and a number of the initial pulse of the vertical synchronization signal.

Based on the driving frequency of the display panel being changed to the second driving frequency, a voltage of the vertical synchronization signal and a number of the initial pulse of the vertical synchronization signal are changed in the at least one frame having the second driving frequency.

A frame period of the display panel may include an active period and a blank period.

The initial pulse of the vertical synchronization signal may be included in the active period.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram showing a display device, according to embodiments;

FIG. 2 is a conceptual diagram showing a variable frequency mode, according to embodiments;

FIG. 3 is a diagram showing a touch vertical synchronization signal according to a comparative example;

FIG. 4 is a diagram showing a touch vertical synchronization signal according to an embodiment;

FIGS. 5 to 9 are diagrams showing specific examples of a vertical synchronization signal and a touch vertical synchronization signal of FIG. 3, according to embodiments;

FIG. 10 is a block diagram showing an electronic device, according to embodiments; and

FIG. 11 is a diagram showing an example in which an electronic device of FIG. 10 is implemented as a smart phone, according to embodiments.

### DETAILED DESCRIPTION OF EMBODIMENTS

Hereinafter, the embodiments will be described in more detail with reference to the accompanying drawings.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

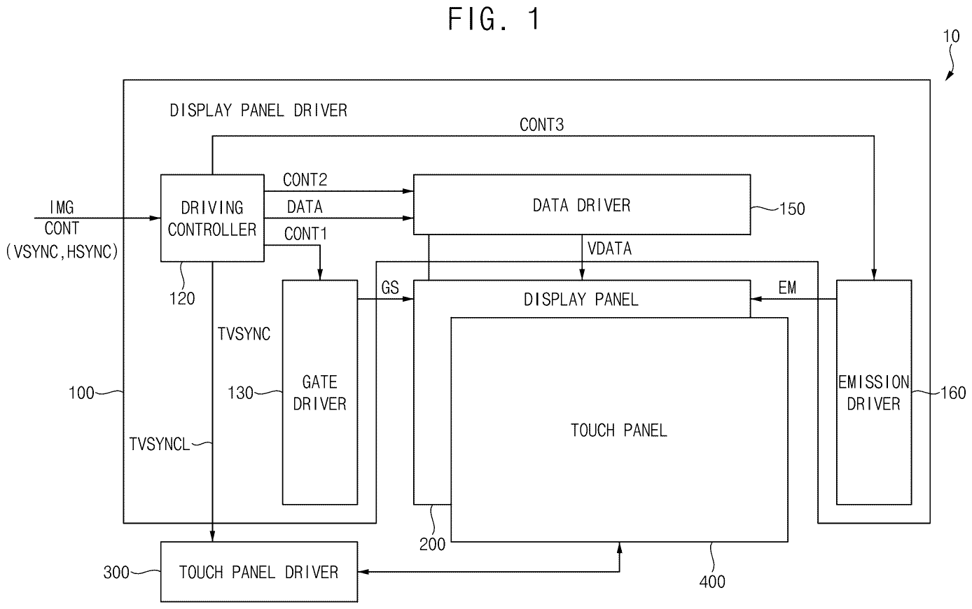

FIG. 1 is a block diagram showing a display device 10 according to embodiments.

Referring to FIG. 1, a display device 10 may include a display module for displaying an image and a touch module for detecting a touch of a user. The display module may include a display panel driver 100 and a display panel 200, and the touch module may include a touch panel driver 300 and a touch panel 400.

The display panel driver 100 may drive the display panel 200 to display an image. The display panel driver 100 may include a driving controller 120, a gate driver 130, a data driver 150, and an emission driver 160.

The display panel 200 may include a display area which may display the image, and a peripheral area arranged adjacent to the display area.

The display panel 200 may include at least one of gate lines, data lines, emission lines, and pixels electrically connected to each of the gate lines, the data lines, and the emission lines.

The driving controller 120 may receive input image data IMG and an input control signal CONT from an external host processor. For example, the input image data IMG may include red image data, green image data, and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal VSYNC and a horizontal synchronization signal HSYNC.

The driving controller 120 may generate a first control signal CONT1, a second control signal CONT2, a third control signal CONT3, and a data signal DATA based on the input image data IMG and the input control signal CONT.

The driving controller 120 may generate the first control signal CONT1 for controlling an operation of the gate driver 130 based on the input control signal CONT, and may provide the first control signal CONT1 to the gate driver 130. The first control signal CONT1 may include the vertical start signal VSYNC and a gate clock signal.

The driving controller 120 may generate the second control signal CONT2 for controlling an operation of the data driver 150 based on the input control signal CONT, and may provide second control signal CONT2 to the data driver 150. The second control signal CONT2 may include the horizontal start signal HSYNC and a load signal.

The driving controller 120 may generate a data signal DATA based on the input image data IMG. The driving controller 120 may provide the data signal DATA to the data driver 150.

The driving controller 120 may generate the third control signal CONT3 for controlling an operation of the emission driver 160 based on the input control signal CONT and provide the third control signal CONT3 to the emission driver 160.

The gate driver 130 may generate gate signals GS for driving the gate lines based on the first control signal CONT1 received from the driving controller 120. The gate driver 130 may provide the gate signals GS to the gate lines.

The data driver 150 may receive the second control signal CONT2 and the data signal DATA from the driving controller 120. The data driver 150 may convert the data signal DATA into an analog data voltage VDATA. The data driver 150 may provide the data voltage VDATA to the data lines.

The emission driver 160 may generate emission signals EM for driving the emission lines based on the third control signal CONT3 received from the driving controller 120. The emission driver 160 may provide the emission signals EM to the emission lines.

In FIG. 1, for convenience of explanation, the gate driver 130 is shown as being disposed on a first side of the display panel 200 and the emission driver 160 is shown as being disposed on a second side of the display panel 200, but embodiments are not limited thereto. For example, in some embodiments, both the gate driver 130 and the emission driver 160 may be disposed on the first side of the display panel 200. As another example, each of the gate driver 130 and the emission driver 160 may be disposed on both sides of the display panel 200. As yet another example, the gate driver 130 and the emission driver 160 may integrated into the display panel 200.

The touch panel driver 300 may drive the touch panel 400 to detect the touch of the user. The touch panel driver 300 may generate a touch driving signal and provide the touch driving signal to the touch panel 400, and may receive a touch sensing signal from the touch panel 400. The touch panel driver 300 may detect the touch of the user based on the touch sensing signal. The touch panel driver 300 may generate touch data representing the detected touch, and may provide the touch data to the display panel driver 100 or the external host processor.

The display module may be driven according to a variable frequency mode for displaying the image at a variable frequency. The driving controller 120 may determine that a driving frequency of the display panel 200 (which may be referred to as a display driving frequency) is changed based on the vertical synchronization signal VSYNC. For example, the vertical synchronization signal VSYNC may include a pulse for each frame. Therefore, the driving controller 120 may calculate the display driving frequency based on a length between consecutive vertical synchronization signals VSYNC in consecutive frames. In this case, because the driving controller 120 may calculate the length between the consecutive vertical synchronization signals VSYNC, the input image data IMG may be delayed by one frame to generate the data signal DATA. However, embodiments are not limited thereto. For example, the driving controller 120 may receive a variable frequency mode signal from the external host processor to determine that the display driving frequency is changed. Here, the variable frequency mode signal may be a signal representing a frequency of the input image data IMG.

The driving controller 120 may modulate the vertical synchronization signal VSYNC to generate a touch vertical synchronization signal TVSYNC. The driving controller 120 may provide the touch vertical synchronization signal TVSYNC to the touch vertical synchronization signal line TVSYNCL connected to the touch panel driver 300.

The touch panel driver 300 may determine a driving frequency of the touch panel 400 (which may be referred to as a touch driving frequency) based on the touch vertical synchronization signal TVSYNC, and may match a driving timing of the touch panel 400 to a driving timing of the display panel 200 in order to drive the touch panel 400 according the variable frequency mode.

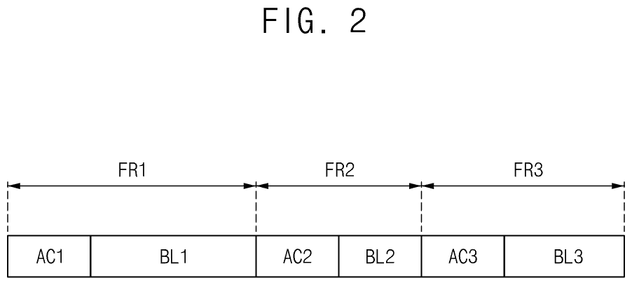

FIG. 2 is a conceptual diagram showing a variable frequency mode.

Referring to FIG. 1 and FIG. 2, the display module may be driven according to the variable frequency mode. As a result, the display driving frequency may vary according to a length of a frame period. For example, based on the length of the frame period being relatively long, the display driving frequency may be relatively small. As another example, based on the length of the frame period being relatively short, the display driving frequency may be relatively large.

A first frame period FR1 having a first frequency may include a first active period AC1 and a first blank period BL1. A second frame period FR2 having a second frequency different from the first frequency may include a second active period AC2 and a second blank period BL2. A third frame FR3 having a third frequency different from the first frequency and the second frequency may include a third active period AC3 and a third blank period BL3.

A length of the first active period AC1 may be equal to a length of the second active period AC2, and a length of the first blank period BL1 may be different from a length of the second blank period BL2.

A length of the second active period AC2 may be equal to a length of the third active period AC3, and a length of the second blank period BL2 may be different from a length of the third blank period BL3.

The frame period for the display module driven in the variable frequency mode may include a data writing period in which the data voltage VDATA is written to the pixel, and a self-scan period in which the data voltage VDATA is not written to the pixel, and only a light is emitted. The data writing period may be arranged within the active periods (e.g., within at least one of the first active period AC1, the second active period AC2, and the third active period AC3). The self-scan period may be arranged within the blank periods (e.g., within at least one of the first blank period BL1, the second blank period BL2, and the third blank period BL3).

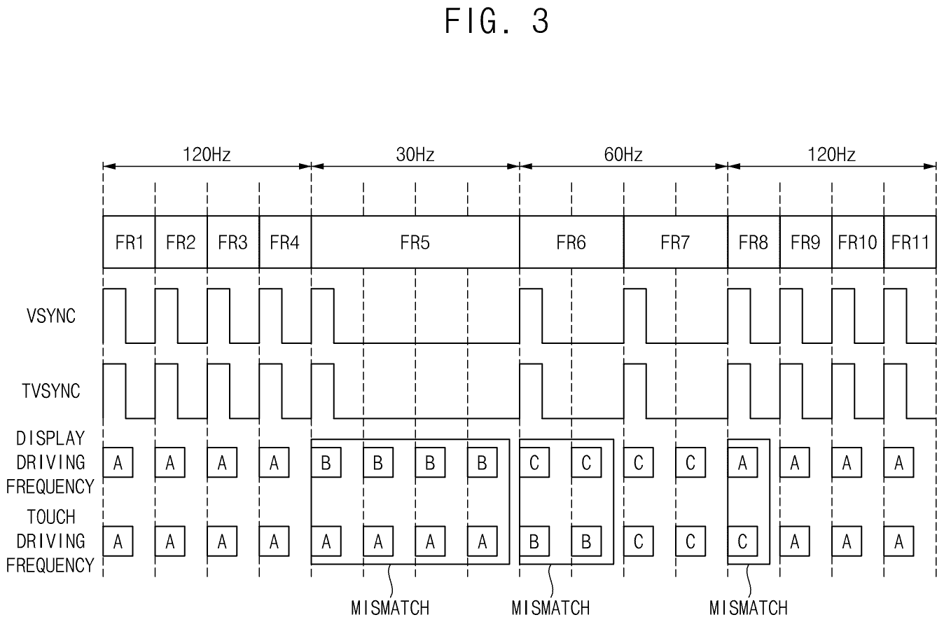

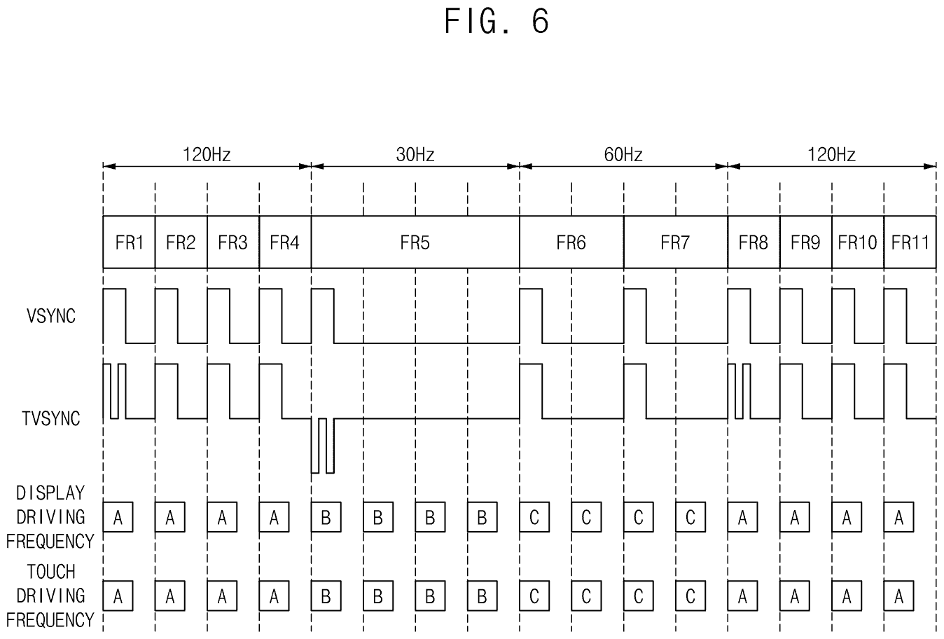

FIG. 3 is a diagram showing a touch vertical synchronization signal TVSYNC according to a comparative example. In FIGS. 3 to 6, frequencies of 120 Hz are labeled as “A”, frequencies of 30 Hz are labeled as “B”, and frequencies of 60 Hz are labeled as “C”.

Referring to FIGS. 1 to 3, the touch vertical synchronization signal TVSYNC according to a comparative example may be equal to the vertical synchronization signal VSYNC. The touch panel driver 300 may determine the driving timing of the touch panel 400 based on the touch vertical synchronization signal TVSYNC.

The touch panel driver 300 may determine that the touch driving frequency is changed based on the touch vertical synchronization signal TVSYNC. For example, the touch vertical synchronization signal TVSYNC may have a pulse for each frame. Therefore, the touch panel driver 300 may calculate the touch driving frequency based on a length between consecutive touch vertical synchronization signals TVSYNC in consecutive frames. In this case, because the touch panel driver 300 may calculate the length between the consecutive touch vertical synchronization signals TVSYNC, the touch panel driver 300 may delay one frame in order to generate the touch driving signal. Therefore, the touch driving frequency may be delayed by one frame from the display driving frequency.

For example, each of first to fourth frame periods FR1 to FR4 may have a display driving frequency of 120 Hz (labeled as “A”). Each of the first to fourth frame periods FR1 to FR4 may have the pulse of the vertical synchronization signal VSYNC. However, each of the first to fourth frame periods FR1 to FR4 may have a touch driving frequency of 120 Hz (labeled as “A”). Each of the first to fourth frame periods FR1 to FR4 may have the pulse of the touch horizontal synchronization signal TVSYNC.

As another example, a fifth frame period FR5 may have a display driving frequency of 30 Hz (labeled as “B”). Therefore, a length of the fifth frame period FR5 may be four times a length of each of the first to fourth frame periods FR1 to FR4. The fifth frame period FR5 may have the pulse of the vertical synchronization signal VSYNC. However, because the touch driving frequency may be delayed by one frame from the display driving frequency, the fifth frame period FR5 may have the touch driving frequency of 120 Hz (labeled as “A”). The fifth frame period FR5 may have the pulse of the touch horizontal synchronization signal TVSYNC. Therefore, in the fifth frame period FR5, the driving timing of the touch panel 400 may not match the driving timing of the display panel 200 (labeled as “MISMATCH”).

As another example, sixth to seventh frame periods FR6 to FR7 may have a display driving frequency of 60 Hz (labeled as “C”). Therefore, a length of each of the sixth to seventh frame periods FR6 to FR7 may be twice the length of each of the first to fourth frame periods FR1 to FR4. Each of the sixth to seventh frame periods FR6 to FR7 may have the pulse of the vertical synchronization signal VSYNC. However, because the touch driving frequency may be delayed by one frame from the display driving frequency, the sixth frame period FR6 may have a touch driving frequency of 30 Hz (labeled as “B”), and the seventh frame period FR7 may have a touch driving frequency of 60 Hz (labeled as “C”). Each of the sixth to seventh frame periods FR6 to FR7 may have the pulse of the touch horizontal synchronization signal TVSYNC. In Therefore, in the sixth frame period FR6, the driving timing of the touch panel 400 may not match the driving timing of the display panel 200 (labeled as “MISMATCH”).

As another example, eighth to eleventh frame periods FR8 to FR11 may have a display driving frequency of 120 Hz (labeled as “A”). Therefore, a length of each of the eighth to eleventh frame periods FR8 to FR11 may be equal to the length of each of the first to fourth frame periods FR1 to FR4. Each of the eighth to eleventh frame periods FR8 to FR11 may have the pulse of the vertical synchronization signal VSYNC. However, because the touch driving frequency may be delayed by one frame from the display driving frequency, the eighth frame period FR8 may have the touch driving frequency of 60 Hz (labeled as “C”), and the ninth to eleventh frame periods FR9 to FR11 may have a touch driving frequency of 120 Hz (labeled as “A”). Each of the eighth to eleventh frame periods FR8 to FR11 may have the pulse of the touch horizontal synchronization signal TVSYNC. Therefore, in the eighth frame period FR8, the driving timing of the touch panel 400 may not match the driving timing of the display panel 200 (labeled as “MISMATCH”).

In summary, in the fifth, sixth, and eighth frame periods FR5, FR6, and FR8, the driving timing of the touch panel 400 may not match the driving timing of the display panel 200, and a delay phenomenon may occur in which the image of the display panel 200 reacts late to the touch of the touch panel 400.

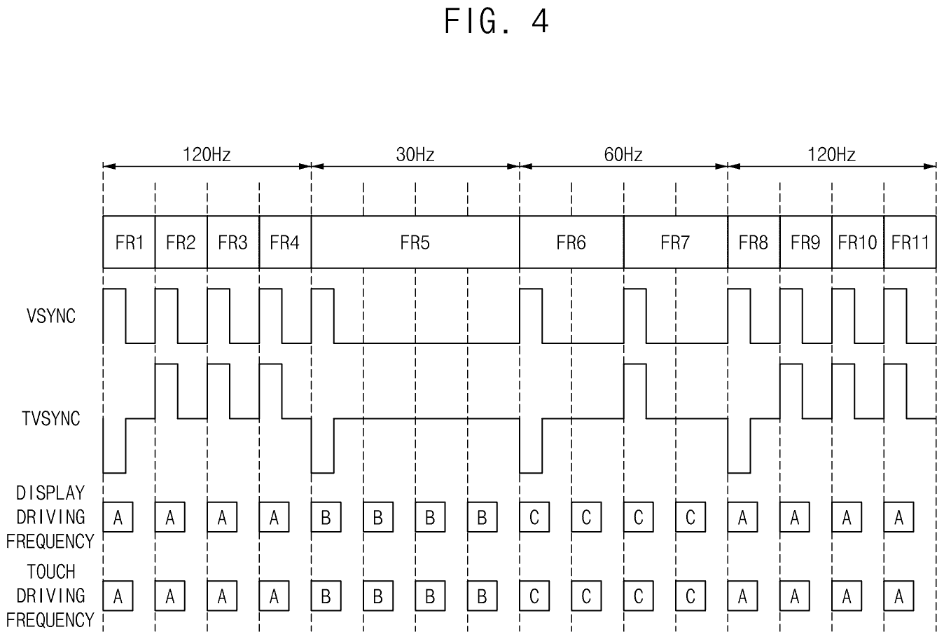

FIG. 4 is a diagram showing a touch vertical synchronization signal TSYNC according to an embodiment.

Referring to FIGS. 1 to 4, a touch vertical synchronization signal TSYNC according to an embodiment may be generated by modulating the vertical synchronization signal VSYNC. For example, based on the display driving frequency being changed from a first driving frequency to a second driving frequency different from the first driving frequency, in at least one frame having the second driving frequency, an initial pulse of the vertical synchronization signal VSYNC may be modulated such that a touch vertical synchronization signal TVSYNC may be generated. Accordingly, the driving timing of the touch panel 400 may match the driving timing of the display panel 200. In addition, because only the touch vertical synchronization signal line TVSYNCL is used to match the driving timing of the touch panel 400 to the driving timing of the display panel 200, a number of a pins used by the touch panel driver 300 may be reduced. In addition, in the at least one frame having the second driving frequency, the touch vertical synchronization signal TVSYNC in which a remaining pulse of the vertical synchronization signal VSYNC are maintained may be generated. Accordingly, other driving of the touch panel 400 may not be affected.

For example, each of first to fourth frame periods FR1 to FR4 may have a display driving frequency of 120 Hz (labeled as “A”). In the first frame period FR1, the display driving frequency may be changed. An initial pulse of the vertical synchronization signal VSYNC in the first to fourth frame periods FR1 to FR4 may be generated in the first frame period FR1. Therefore, the pulse of the vertical synchronization signal VSYNC in the first frame period FR1 may be modulated such that a touch vertical synchronization signal TVSYNC may be generated. Even if the touch panel driver 300 does not calculate the touch driving frequency based on a length between consecutive touch vertical synchronization signals TVSYNC in consecutive frames, the touch panel driver 300 may generate the touch driving signal without a delay based on the touch vertical synchronization signal TVSYNC in the first frame period FR1. The first to fourth frame periods FR1 to FR4 may have a touch driving frequency of 120 Hz (labeled as “A”). Therefore, in the first to fourth frame periods FR1 to FR4, a driving timing of the touch panel 400 may match a driving timing of the display panel 200.

As another example, the fifth frame period FR5 may have a display driving frequency of 30 Hz (labeled as “B”). In the fifth frame period FR5, the display driving frequency may be changed. An initial pulse of the vertical synchronization signal VSYNC in the fifth frame period FR5 may be generated in the fifth frame period FR5. Therefore, the pulse of the vertical synchronization signal VSYNC in the fifth frame period FR5 may be modulated such that the touch vertical synchronization signal TVSYNC may be generated. Even if the touch panel driver 300 does not calculate the touch driving frequency based on the length between the consecutive touch vertical synchronization signals TVSYNC in the consecutive frames, the touch panel driver 300 may generate the touch driving signal without the delay based on the touch vertical synchronization signal TVSYNC in the fifth frame period FR5. The fifth frame period FR5 may have a touch driving frequency of 30 Hz. Therefore, the driving timing of the touch panel 400 in the fifth frame period FR5 may match the driving timing of the display panel 200.

As another example, each of the sixth to seventh frame periods FR6 to FR7 may have a display driving frequency of 60 Hz (labeled as “C”). In the sixth frame period FR6, the display driving frequency may be changed. An initial pulse of the vertical synchronization signal VSYNC in the sixth to seventh frame periods FR6 to FR7 may be generated in the sixth frame period FR6. Therefore, the pulse of the vertical synchronization signal VSYNC in the sixth frame period FR6 may be modulated such that the touch vertical synchronization signal TVSYNC may be generated. Even if the touch panel driver 300 does not calculate the touch driving frequency based on the length between the consecutive touch vertical synchronization signals TVSYNC in the consecutive frames, the touch panel driver 300 may generate the touch driving signal without a delay based on the touch vertical synchronization signal TVSYNC in the sixth frame period FR6. The sixth to seventh frame periods FR6 to FR7 may have a touch driving frequency of 60 Hz (labeled as “C”). Therefore, the driving timing of the touch panel 400 in the sixth to seventh frame periods FR6 to FR7 may match the driving timing of the display panel 200.

As another example, each of the eighth to eleventh frame periods FR8 to FR11 may have a display driving frequency of 120 Hz (labeled as “A”). In the eighth frame period FR8, the display driving frequency may be changed. An initial pulse of the vertical synchronization signal VSYNC in the eighth to eleventh frame periods FR8 to FR11 may be generated in the eighth frame period FR8. Therefore, the pulse of the vertical synchronization signal VSYNC in the eighth frame period FR8 may be modulated such that a touch vertical synchronization signal TVSYNC may be generated. Even if the touch panel driver 300 does not calculate the touch driving frequency based on the length between consecutive touch vertical synchronization signals TVSYNC in the consecutive frames, the touch panel driver 300 may generate the touch driving signal without the delay based on the touch vertical synchronization signal TVSYNC in the eighth frame period FR8. The eighth to eleventh frame periods FR8 to FR 11 may have a touch driving frequency of 120 Hz (labeled as “A”). Therefore, the driving timing of the touch panel 400 in the eighth to eleventh frame periods FR8 to FR11 may match the driving timing of the display panel 200.

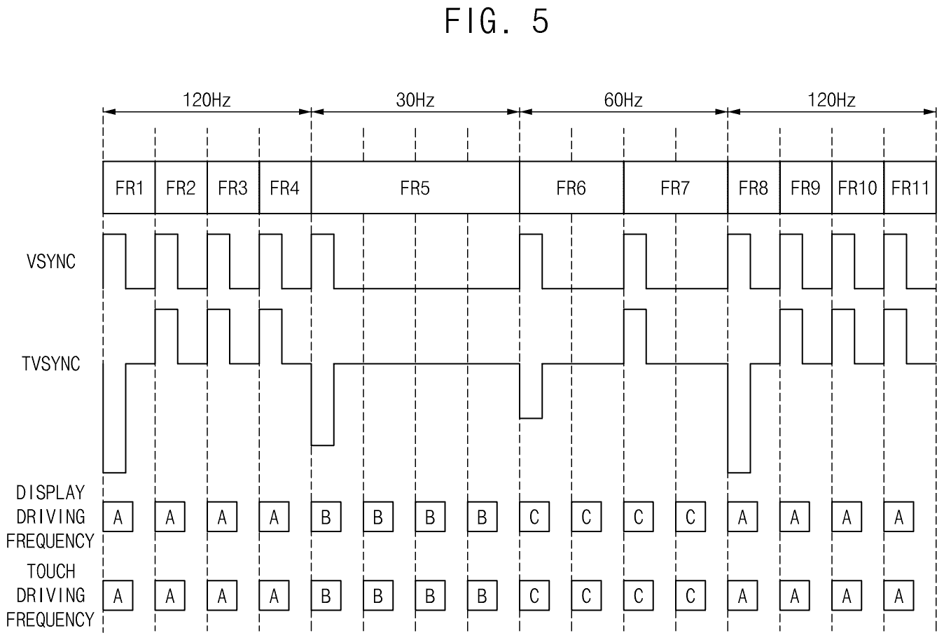

FIGS. 5 to 9 are diagrams showing specific examples of a vertical synchronization signal VSYNC and a touch vertical synchronization signal TVSYNC of FIG. 3.

Referring to FIGS. 1 to 5, the touch vertical synchronization signal TVSYNC according to an embodiment may be generated by modulating the vertical synchronization signal VSYNC. For example, based on the display driving frequency being changed from a first driving frequency to a second driving frequency different from the first driving frequency, in at least one frame having the second driving frequency, an initial pulse of the vertical synchronization signal VSYNC may be modulated such that a touch vertical synchronization signal TVSYNC may be generated. Accordingly, the driving timing of the touch panel 400 may match the driving timing of the display panel 200. In addition, because only the touch vertical synchronization signal line TVSYNCL is used to match the driving timing of the touch panel 400 to the driving timing of the display panel 200, a number of pins used by the touch panel driver 300 may be reduced. In addition, in the at least one frame having the second driving frequency, a touch vertical synchronization signal TVSYNC in which a remaining pulse of the vertical synchronization signal VSYNC is maintained may be generated. Accordingly, other driving of the touch panel 400 may not be affected. However, since this has been described above, a redundant description thereof will be omitted.

In the at least one frame having the second driving frequency, the driving controller 120 may modulate a voltage of the initial pulse of the vertical synchronization signal VSYNC. In embodiments, when the second driving frequency is different, in the at least one frame having the second driving frequency, the voltage of the initial pulse of the vertical synchronization signal VSYNC may be different.

For example, based on the second driving frequency being 120 Hz, the voltage of the initial pulse of the vertical synchronization signal VSYNC may be −1.8 V. As another example, based on the second driving frequency being 30 Hz, the voltage of the initial pulse of the vertical synchronization signal VSYNC may be −0.9 V. As yet another example, based on the second driving frequency being 60 Hz, the voltage of the initial pulse of the vertical synchronization signal VSYNC may be −1.2 V.

Accordingly, in the at least one frame having the second driving frequency, based on the initial pulse of the vertical synchronization signal VSYNC being modulated such that the touch vertical synchronization signal TVSYNC is generated, the touch panel driver 300 may determine that the touch driving frequency is changed based on the touch vertical synchronization signal TVSYNC. In addition, the touch panel driver 300 may determine the touch driving frequency based on the voltage of the initial pulse of the vertical synchronization signal VSYNC.

Referring to FIGS. 1 to 4 and FIG. 6, the touch vertical synchronization signal TSYNC according to an embodiment may be generated by modulating the vertical synchronization signal VSYNC. For example, based on the display driving frequency being changed from a first driving frequency to a second driving frequency different from the first driving frequency, in at least one frame having the second driving frequency, an initial pulse of the vertical synchronization signal VSYNC may be modulated such that a touch vertical synchronization signal TVSYNC may be generated. Accordingly, the driving timing of the touch panel 400 may match the driving timing of the display panel 200. In addition, because only the touch vertical synchronization signal line TVSYNCL is used to match the driving timing of the touch panel 400 to the driving timing of the display panel 200, a number of pins used by the touch panel driver 300 may be reduced. In addition, in the at least one frame having the second driving frequency, the touch vertical synchronization signal TVSYNC in which a remaining pulse of the vertical synchronization signal VSYNC is maintained may be generated. Accordingly, other driving of the touch panel 400 may not be affected. However, because similar examples are described above, a redundant description thereof may be omitted.

In the at least one frame having the second driving frequency, the driving controller 120 may modulate a voltage and a number of the initial pulse of the vertical synchronization signal VSYNC. For example, when the second driving frequency is different, in the at least one frame having the second driving frequency, the voltage and the number of the initial pulse of the vertical synchronization signal VSYNC may be different.

For example, based on the second driving frequency being 120 Hz, the voltage of the initial pulse of the vertical synchronization signal VSYNC may be 1.8 V, and the number of the initial pulses of the vertical synchronization signal VSYNC may be two. As another example, based on the second driving frequency being 30 Hz, the voltage of the initial pulse of the vertical synchronization signal VSYNC may be −1.8 V, and the number of the initial pulses of the vertical synchronization signal VSYNC may be two. As yet another example, based on the second driving frequency being 120 Hz, the voltage of the initial pulse of the vertical synchronization signal VSYNC may be 1.8 V, and the number of the initial pulses of the vertical synchronization signal VSYNC may be one.

As such, in the at least one frame having the second driving frequency, based on the initial pulse of the vertical synchronization signal VSYNC being modulated such that the touch vertical synchronization signal TVSYNC is generated, the touch panel driver 300 may determine that the touch driving frequency is changed based on the touch vertical synchronization signal TVSYNC. In addition, the touch panel driver 300 may determine the touch driving frequency based on the voltage and the number of the initial pulses of the vertical synchronization signal VSYNC.

According to embodiments, in FIGS. 3 to 6, a frame period of the display panel 200 may include an active period (e.g., a first active period AC1, a second active period AC2, or a third active period AC3) and a blank period (e.g., a first blank period BL1, a second blank period BL2, and a third blank period BL3), as shown in FIG. 2. In this case, in the at least one frame having the second driving frequency, the initial pulse of the vertical synchronization signal VSYNC may be included in the active period (e.g., in at least one of the first active period AC1, the second active period AC2, and the third active period AC3). However, embodiments are not limited thereto.

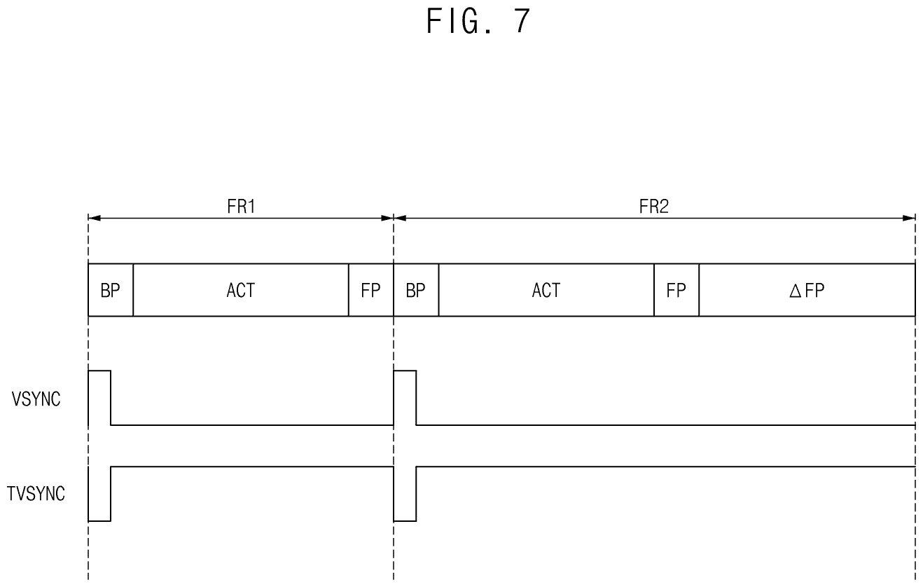

Referring to FIGS. 1, 2, and 7 to 9, the frame period of the display panel 200 may include a front porch period FP, an active period ACT, and a back porch period BP. The frame period of the display panel 200 may further include a variable front porch period ΔFP. An active period ACT of FIGS. 7 to 9 may correspond to one or more of the active (e.g., the first active period AC1, the second active period AC2, and the third active period AC3) of FIG. 2, and the front porch period FP, the back porch period BP, and the variable front porch period ΔFP of FIGS. 7 to 9 may correspond to one or more of the blank periods (e.g., the first blank period BL1, the second blank period BL2, and the third blank period BL3) of FIG. 2.

In the front porch period FP, the driving controller 120 may provide a synchronization signal to the external host processor, and in the back porch period BP, the external host processor may provide the vertical synchronization signal VSYNC and the input image data IMG to the driving controller 120. For example, the front porch period FP and the back porch period BP may be periods in which a timing of the external host processor and a timing of the driving controller 120 are synchronized.

The active period may be a period in which the data voltage VDATA is applied to the pixel.

Based on the display driving frequency being a frame frequency that is less than a maximum driving frequency, the frame period of the display panel 200 may include the variable front porch period ΔFP. Based on a length of the variable front porch period ΔFP being increased, the display driving frequency may decrease. Based on the length of the variable front porch period ΔFP being decreased, the display driving frequency may increase. For example, a display driving frequency in the first frame period FR1 may be the maximum driving frequency and may be greater than a display driving frequency in the second frame period FR2. In this case, the first frame period FR1 may not include the variable front porch period ΔFP, and the second frame period FR2 may include the variable front porch period ΔFP.

In this case, in the at least one frame having the second driving frequency, the initial pulse of the vertical synchronization signal VSYNC may be included in the back porch period BP. However, embodiments are not limited thereto.

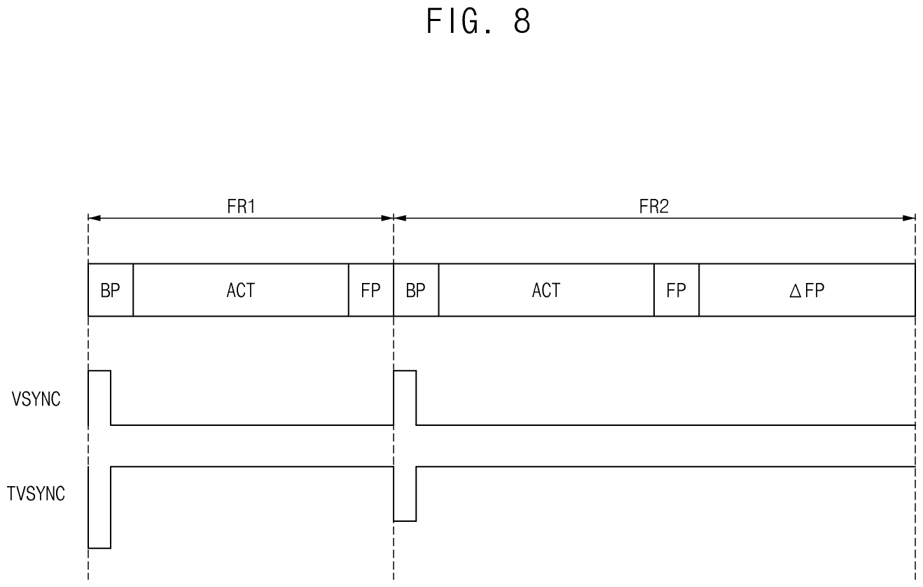

As shown in FIG. 8, in the at least one frame having the second driving frequency, the driving controller 120 may modulate a voltage of the initial pulse of the vertical synchronization signal VSYNC. For example, based on the second driving frequency being different, in the at least one frame having the second driving frequency, the voltage of the initial pulse of the vertical synchronization signal VSYNC may be different.

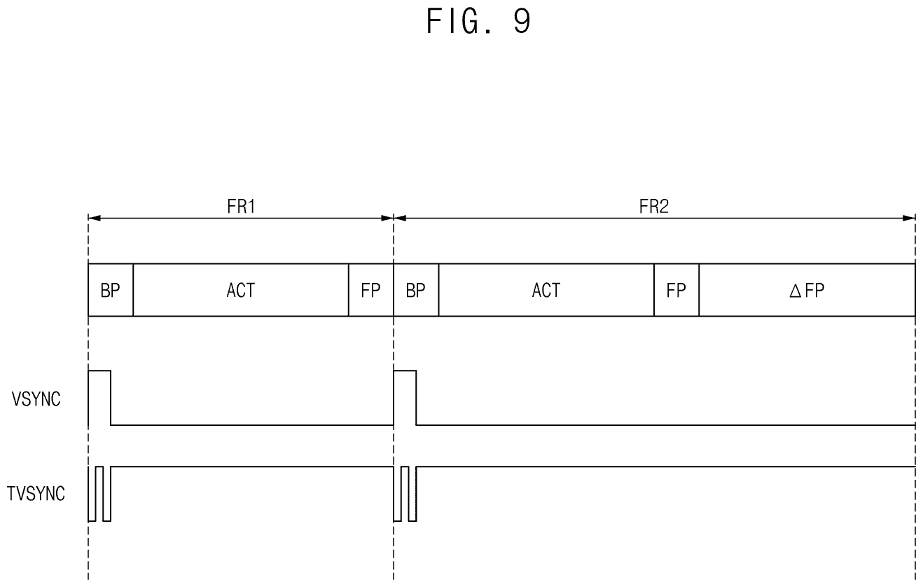

As shown in FIG. 9, in the at least one frame having the second driving frequency, the driving controller 120 may modulate the number of the initial pulses of the vertical synchronization signal VSYNC. For example, based on the second driving frequency being different, in the at least one frame having the second driving frequency, the number of the initial pulses of the vertical synchronization signal VSYNC may be different.

As such, in the at least one frame having the second driving frequency, based on the initial pulse of the vertical synchronization signal VSYNC being modulated such that the touch vertical synchronization signal TVSYNC is generated, the touch panel driver 300 may determine that the touch driving frequency is changed based on the touch vertical synchronization signal TVSYNC. In addition, the touch panel driver 300 may determine the touch driving frequency based on the voltage of the initial pulse of the vertical synchronization signal VSYNC.

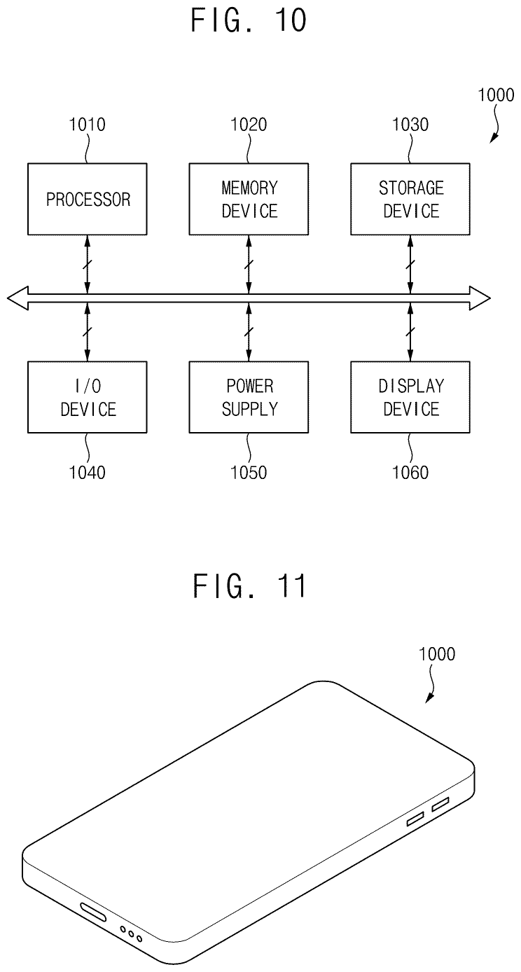

FIG. 10 is a block diagram showing an electronic device 1000. FIG. 11 is a diagram showing an embodiment in which the electronic device 1000 of FIG. 10 is implemented as a smart phone.

Referring to FIGS. 10 and 11, an electronic device 1000 may include a processor 1010, a memory device 1020, a storage device 1030, an input/output (I/O) device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus USB device, other electronic device, and the like.

In an embodiment, as shown in FIG. 11, the electronic device 1000 may be implemented as a smart phone. However, the electronic device 1000 is not limited thereto. For example, the electronic device 1000 may be implemented as a cellular phone, a video phone, a smart pad, a smart watch, a personal computer (PC) a tablet PC, a car navigation system, a computer monitor, a laptop, a head mounted display (HMD) device, and the like.

The processor 1010 may perform various computing functions. The processor 1010 may be or may include at least one of a microprocessor, a central processing unit (CPU), an application processor (AP), and the like. The processor 1010 may be coupled to other components using at least one of an address bus, a control bus, a data bus, and the like. Further, the processor 1010 may be coupled to an extended bus such as a peripheral component interconnection PCI bus.

The memory device 1020 may store data for operations of the electronic device 1000. For example, the memory device 1020 may include at least one nonvolatile memory device such as an erasable programmable read-only memory (EPROM) device, an electrically erasable programmable read-only memory (EEPROM) device, a flash memory device, a phase change random access memory (PRAM device, a resistance random access memory (RRAM) device, a nano floating gate memory (NFGM) device, a polymer random access memory (PoRAM) device, a magnetic random access memory (MRAM) device, a ferroelectric random access memory FRAM device, and the like and/or at least one volatile memory device such as a dynamic random access memory (DRAM) device, a static random access memory SRAM device, a mobile DRAM device, and the like.

The storage device 1030 may include a solid state drive (SSD) device, a hard disk drive (HDD) device, a compact disc-read only memory (CD-ROM) device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

Embodiments may be applied to any display device and any electronic device including the touch panel. For example, embodiments may be applied to a mobile phone, a smart phone, a tablet computer, a digital television (TV), a three-dimensional (3D) TV, a PC, a home appliance, a laptop computer, a personal digital assistant (PDA), a portable multimedia player (PMP), a digital camera, a music player, a portable game console, a navigation device, etc.

The foregoing description is illustrative of the present disclosure and is not to be construed as limiting thereof. Although some particular embodiments are described above, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing description is illustrative, and the present disclosure is not to be construed as limited to the specific embodiments described above, and that modifications to the described embodiments, as well as other embodiments, are intended to be included within the scope of the appended claims. The present disclosure is defined by the following claims, with equivalents of the claims to be included therein.

What is claimed is:

1. A display device, comprising:
a display panel configured to display an image;
a touch panel configured to detect a touch;
a display panel driver configured to drive the display panel according to a variable frequency mode, and to modulate a vertical synchronization signal to generate a touch vertical synchronization signal; and
a touch panel driver configured to determine a driving timing of the touch panel based on the touch vertical synchronization signal, and to match the driving timing of the touch panel to a driving timing of the display panel to drive the touch panel according to the variable frequency mode.

2. The display device of claim 1, wherein the display panel driver is further configured to, based on a driving frequency of the display panel being changed from a first driving frequency to a second driving frequency different from the first driving frequency, modulate an initial pulse of the vertical synchronization signal in at least one frame having the second driving frequency.

3. The display device of claim 2, wherein the display panel driver is further configured to maintain a remaining pulse of the vertical synchronization signal in at least one frame having the second driving frequency.

4. The display device of claim 2, wherein the display panel driver is further configured to modulate a voltage of the initial pulse of the vertical synchronization signal.

5. The display device of claim 4, wherein, based on the driving frequency of the display panel being changed to the second driving frequency, the voltage of the initial pulse of the vertical synchronization signal is changed in at least one frame having the second driving frequency.

6. The display device of claim 2, wherein the display panel driver is further configured to modulate a voltage and a number of the initial pulse of the vertical synchronization signal.

7. The display device of claim 6, wherein, based on the driving frequency of the display panel being changed to the second driving frequency, the voltage and the number of the initial pulse of the vertical synchronization signal are changed in at least one frame having the second driving frequency.

8. The display device of claim 2, wherein a frame period of the display panel includes an active period and a blank period.

9. The display device of claim 8, wherein the initial pulse of the vertical synchronization signal is included in the active period.

10. The display device of claim 2, wherein a frame period of the display panel comprises a front porch period, an active period, and a back porch period.

11. The display device of claim 10, wherein the initial pulse of the vertical synchronization signal is included in the back porch period.

12. An electronic device, comprising:
a host processor configured to output a vertical synchronization signal;
a display panel configured to display an image;
a touch panel configured to detect a touch;
a display panel driver configured to drive the display panel according to a variable frequency mode, and to modulate the vertical synchronization signal to generate a touch vertical synchronization signal; and
a touch panel driver configured to determine a driving timing of the touch panel based on the touch vertical synchronization signal, and to match the driving timing of the touch panel to a driving timing of the display panel to drive the touch panel according to the variable frequency mode.

13. The electronic device of claim 12, wherein the display panel driver is further configured to, based on a driving frequency of the display panel being changed from a first driving frequency to a second driving frequency different from the first driving frequency, modulate an initial pulse of the vertical synchronization signal in at least one frame having the second driving frequency.

14. The electronic device of claim 13, wherein the display panel driver is further configured to maintain a remaining pulse of the vertical synchronization signal in at least one frame having the second driving frequency.

15. The electronic device of claim 14, wherein the display panel driver is further configured to modulate a voltage of the initial pulse of the vertical synchronization signal.

16. The electronic device of claim 13, wherein, based on the driving frequency of the display panel being changed to the second driving frequency, a voltage of the initial pulse of the vertical synchronization signal is changed in at least one frame having the second driving frequency.

17. The electronic device of claim 16, wherein the display panel driver is further configured to modulate the voltage of the vertical synchronization signal and a number of the initial pulse of the vertical synchronization signal.

18. The electronic device of claim 13, wherein, based on the driving frequency of the display panel being changed to the second driving frequency, a voltage of the vertical synchronization signal and a number of the initial pulse of the vertical synchronization signal are changed in the at least one frame having the second driving frequency.

19. The electronic device of claim 18, wherein a frame period of the display panel comprises an active period and a blank period.

20. The display device of claim 19, wherein the initial pulse of the vertical synchronization signal is included in the active period.
